(19) United States
(12) Patent Application Publication
(10) Pub. No.: US 2006/0120434 A1
(43) Pub. Date: Jun. 8, 2006

(54) Enhanced optical fast frequency hopping-cdma by means of over spreading and interleaving

(76) Inventors: Habib Fathallah, Sainte-Foy (CA); Kerim Fouli, Sainte-Foy (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/529,229

(22) PCT Filed: Sep. 24, 2003
(86) PCT No.: PCT/CA03/01460

§ 371 Date: Sep. 19, 2005

Related U.S. Application Data
(60) Provisional application No. 60/413,134, filed on Sep. 25, 2002.

(51) Int. Cl. H04B 1/713

(52) U.S. Cl. 375/132

(57) ABSTRACT

A method and an optical communication system for a practical implementation of fast frequency hopping-code division multiple access in optical networks allowing higher transmission bandwidth is provided. The method comprises the step a) of providing a fast frequency hopping CDMA coded optical signal comprising a plurality of user's bits of a plurality of users. The method also comprises the step b) of over spreading in a time axis each of the user's bits of the fast frequency hopping CDMA coded optical signal. The method also comprises the step c) of interleaving each of the user's bits of a given user with a successive user's bit of the given user. After steps a), b) and c), the method comprises the step d) of transmitting the fast frequency hopping CDMA coded optical signal over the optical network. The method also comprises, after step d), the step e) of over de-spreading in the time axis each of the user's bits of the fast frequency hopping CDMA coded optical signal. The method also comprises the step f) of deinterleaving each of the user's bits of the fast frequency hopping CDMA coded optical signal from the successive user's bit.

### FIELD OF THE INVENTION

The present invention relates generally to the field of Optical Code Division Multiple Access (CDMA) and more particularly concerns a technique of optical fast frequency hopping (OFFH) for use in fiber optic communication networks.

### BACKGROUND OF THE INVENTION

Optical code division multiple access is a technique of multiplexing streams of information bits in an optical waveguide, as described in FIGS. 1A, 1B and 1C (PRIOR ART). The multiplexing is done by 1) encoding every data stream in the optical field using a separate code, introducing spectrum and/or time spreading of every data signal (FIG. 1B), 2) feeding all encoded signals into a common optical waveguide in a specific frequency and/or time and/or space, 3) the mix of optical signals travel through the waveguide for an undetermined distance, 4) in the reception site (FIG. 1C), any encoded signal can be decoded, simultaneously de-spread, by means of a decoder having the inverse transfer function of the encoder, allowing reconstitution of the data signal in a detectable form.

CDMA is an advantageous multiplexing technique widely used in radio frequency communications, and much effort has been devoted to adapt this technology to optical systems. Several optical encoding technologies have been proposed in the last two decades, trying to reproduce the wireless success in fiber optic networks. It has however proven challenging to develop frequency hopping CDMA techniques for optical applications, since the agility of modern radio transmitters to quickly change transmission frequencies has no obvious corollary in optics. An ingenious solution to this problem is to use multiple Bragg gratings to generate a “hopping” pattern, as shown in FIGS. 2 and 3 (PRIOR ART) (see for example H. Fathallah et al. “Analysis of an optical frequency-hop encoder using strain-tuned Bragg gratings,” submitted to USA Topical Meeting on Bragg Gratings, photosensitivity and Poling in Glass Fibers and Waveguides—Applications and Fundamentals, October 1997). Each Bragg grating selects a particular frequency bin from a broadband optical signal, and the physical separation between the gratings determines the temporal separation between the reflected pulses. Only one bit at a time is allowed to circulate in the multiple Bragg grating structure, the minimum duration of one bit being therefore limited to the round trip time of light therein.

FIGS. 4A to 4F (PRIOR ART) illustrates the different signal processing steps in an optical fast frequency hopping-CDMA system based on the principle of FIGS. 2 and 3, assuming an incoherent broadband source is used. FIG. 4A shows a data stream 1101 presented with logic levels; FIG. 4B shows the low duty-cycle return to zero modulated signal; FIG. 4C shows the time X frequency representation of the modulated incoherent broadband source; FIG. 4D shows the time X frequency representation of the signal after the encoding step; FIG. 4E shows the amplitude X time representation of the encoded data stream; finally, FIG. 4F shows the frequency X time representation of the decoded signal. The parameters Wb, Wss, Tb, Tc, Wc and M are respectively defined as follows: Wb is the wavelength interval used by a bit, Wss is the wavelength interval used by the system for encoding (which is here equal to Wb), Tb is the bit duration, Tc is the chip duration (which is here equal to the fifth of the bit duration), Wc is the wavelength interval used by a chip, and M is the number of chips in the code (here set to five). Note that the duration of the ON segment of the RZ waveform used in the broadband modulated is equal to Tc. If we want to make Tc too short in order to increase the bandwidth and/or to increase the time dimension length of the code, we would become limited by the hardware of the mirrors of FIGS. 2 and 3. The same limitation is observed when we try to increase the bit rate, hence reduce the duration of the bit Tb. Therefore, It would be desirable to propose solution for this and allow much finer chip-time and higher bandwidth transmission.

FIG. 5 illustrates all the processing steps starting from the modulation of the data to its recovery in the receiver, this time assuming a coherent broadband pulsed source. It should be noted that coherent broadband pulsed lasers generate pulses with an amplitude X frequency function that is a Fourier transform of its Amplitude X time function. Filtering a narrow frequency interval from the coherent broadband pulse (for examples a narrow part of 1/F^{th} the width of source bandwidth) leads to signal waveform with much longer duration (i.e., F time longer than the original broadband laser pulse). Since the light is coherent, the Fourier transform applies hence for the filtered narrowband signal. In the present example, FIG. 5A shows a data stream 110; FIG. 5B shows coherent broadband laser pulses representing low duty-cycle return to zero (RZ) waveforms modulated by the data stream of FIG. 5A; FIG. 5C shows a frequency X time representation of the data modulated signal; FIG. 5D is a frequency X time representation of the optical signal encoded by an OFFH-CDMA encoder; FIG. 5E shows an amplitude X time representation of the data stream after encoding/spreading operations (note the spreading of the chip pulses over the time axis); and FIG. 5F shows the frequency X time representation of the decoded signal.

In the case of coherent source, the pulse duration Tp is different from the chip duration Tc, it is assumed to be much smaller than Tc. Generally, Tc=F*Tp, where Wc=Wb/F and Tb=M*Tc. It is important to maintain no overlap between chip pulses after spreading in order to accurately respect the performance properties expected by the selected codes.

A difficulty encountered with this approach is that increasing the chip rate, which is the number of frequency bins per time period, involves a reduction of the spacing between the gratings, which can prove practically difficult for high chip rates. Similarly, when the data bit rate increases, the whole length of the multiple Bragg grating structure must be reduced. Higher data bit rates therefore involve placing each grating on an increasingly small fiber segment, once again making it difficult to manufacture the multiple Bragg grating structure. For example, FIGS. 12A and 12B (PRIOR ART) show respectively a low and a high bit rate encoders with a chip duration L_{CLR} and L_{CHR} (L_{CHR}<L_{CLR}). The latter shows that further increasing the bit rate would not be physically possible because of the gratings lengths and their packaging systems. In this system the chip duration, and similarly the bit duration, is limited by the physical length of the gratings and their packaging systems.

It can be seen that CDMA is fundamentally limited by the coding properties, and that the hardware restrictions of the prior art limit the flexibility of CDMA to be used at full capacity. Even if the above analysis is applied to the use of Bragg Gratings, the problem and the solution as well apply for any other technology used to implement OFFH coding, i.e., other mirror technology for example.

There is therefore a need for an OFFH-CDMA system allowing higher chip rates and data rates without requiring Bragg gratings or other reflectors having characteristics that are hard to obtain using the current manufacturing technologies.

### SUMMARY OF THE INVENTION

The present invention alleviates the disadvantages of the prior art devices in providing a method and an optical communication system using an over spreading and interleaving of data bits, allowing the coding technique to support very high bandwidth and several additional features.

Accordingly, it is an object of the present invention to provide a method of fast frequency hopping CDMA coding of optical signals for transmission over an optical network. the method comprising the steps of:
a) providing a fast frequency hopping CDMA coded optical signal comprising a plurality of user's bits of a plurality of users;
b) over spreading in a time axis each of said user's bits of said fast frequency hopping CDMA coded optical signal;
c) interleaving each of said user's bits of a given user with a successive user's bit of said given user;
d) after steps a), b) and c), transmitting said fast frequency hopping CDMA coded optical signal over the optical network;
e) after step d), over de-spreading in the time axis each of said user's bits of said fast frequency hopping CDMA coded optical signal; and
f) de-interleaving each of said user's bits of said fast frequency hopping CDMA coded optical signal from said successive user's bit.

It is another object of the present invention to provide a transmitter for transmitting over an optical network a fast frequency hopping CDMA coded optical signal comprising a plurality of user's bits of a plurality of users, each of the user's bits comprising a predetermined number of chips. The transmitter comprises an encoding means for over spreading in a time axis each of the user's bits of the fast frequency hopping CDMA coded optical signal and interleaving each of the user's bits of a given user with a successive user's bit of the given user.

In a preferred embodiment of the present invention, the encoding means comprises a plurality of Bragg gratings of a predetermined length, each of said gratings being serialized in an optical link. The optical link comprises a plurality of time delay lines, each of the time delay lines extending between two adjacent gratings.

It is another object of the present invention to provide an optical communication system for exchanging over an optical network a fast frequency hopping CDMA coded optical signal comprising a plurality of user's bits of a plurality of users. The optical communication system is provided with a transmitter comprising an encoding means for over spreading in a time axis each of the user's bits of the fast frequency hopping CDMA coded optical signal and interleaving each of the user's bits of a given user with a successive user's bit of the given user. The optical communication system is also provided with a receiver comprising a decoding means for over de-spreading in a time axis each of the user's bits of the fast frequency hopping CDMA coded optical signal and de-interleaving each of the user's bits of a given user from the successive user's bit of the given user.

### BRIEF DESCRIPTION OF THE DRAWINGS

These and other objects and advantages of the present invention will become apparent upon reading the detailed description and upon referring to the drawings in which:

FIG. 1A (PRIOR ART) is a block diagram of a typical OCDMA network.

FIG. 1B (PRIOR ART) is a block diagram of a typical encoding operation in a transmitter of the typical OCDMA network shown in FIG. 1.

FIG. 1C (PRIOR ART) is a block diagram of a typical decoding operation in a receiver of the typical OCDMA network shown in Figure 1.

FIG. 2 (PRIOR ART) illustrates an optical fast frequency hopping (OFFH) CDMA encoder/decoder based on band reflective filters according to the prior art.

FIG. 3 (PRIOR ART) illustrates an optical fast frequency hopping (OFFH) CDMA encoder/decoder based on Bragg gratings according to the prior art.

FIGS. 4A through 4F (PRIOR ART) are graphical representations of the signal processing steps in a prior art optical fast frequency hopping CDMA system when an incoherent broadband source is used.

FIGS. 5A through 5F (PRIOR ART) are graphical representations of the signal processing steps in a prior art optical fast frequency hopping CDMA system when a coherent broadband source is used.

FIG. 6A is a block diagram of a new OFFH-CDMA network according to a preferred embodiment of the present invention.

FIG. 6B is a block diagram of an encoding operation of the transmitter of the OFFH-CDMA network of FIG. 6A.

FIG. 6C is a block diagram of a decoding operation of the receiver of the FFH-CDMA network of FIG. 6A.

FIGS. 7A through 7E are graphical representations of the signal processing steps in a new OFFH-CDMA system according to a preferred embodiment of the present invention when an incoherent broadband source is used.

FIGS. 8A through 8E are graphical representations of the signal processing steps in a new OFFH-CDMA system according to a preferred embodiment of the present invention when a coherent broadband source is used.

FIG. 9 is an illustration of a new OFFH-CDMA encoder/decoder based on band reflective filters according to a preferred embodiment of the present invention.

FIG. 10 is an illustration of another OFFH-CDMA encoder/decoder based on filtering devices with one input and two outputs according to another preferred embodiment of the present invention.

FIG. 11 is an illustration of another OFFH-CDMA encoder/decoder based on Bragg gratings.

FIGS. 12A and 12B (PRIOR ART) respectively show high and low bit rate encoders/decoders according to prior art.

FIGS. 13A and 13B respectively show low and high bit rate encoder/decoders according to another preferred embodiment of the present invention.

FIG. 14 illustrates an economic and compact packaging for an encoder/decoder according to another preferred embodiment of the present invention.

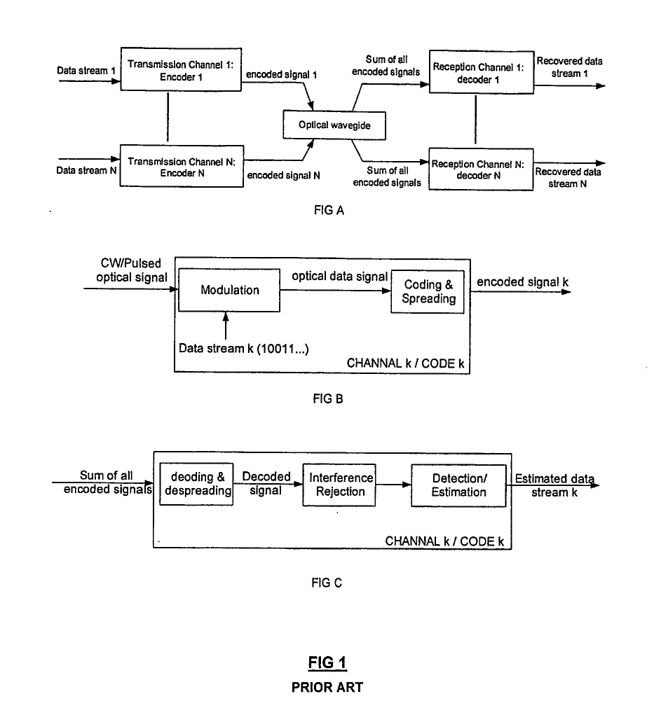

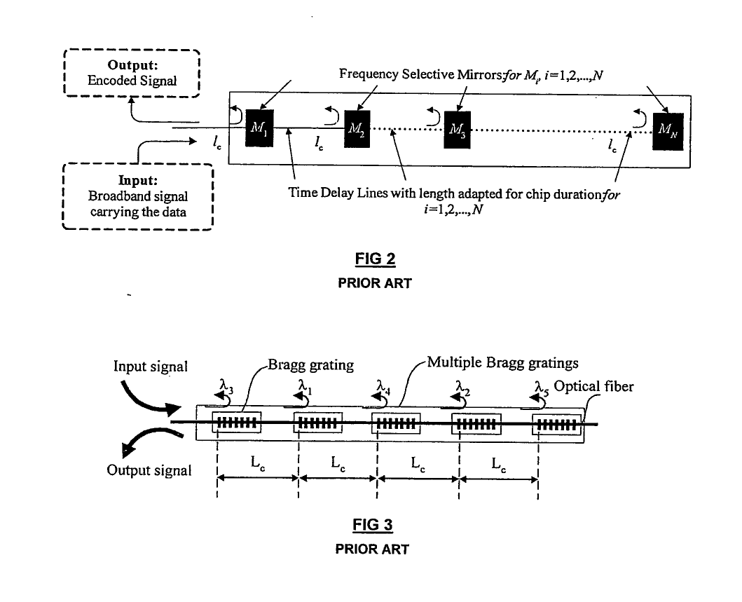

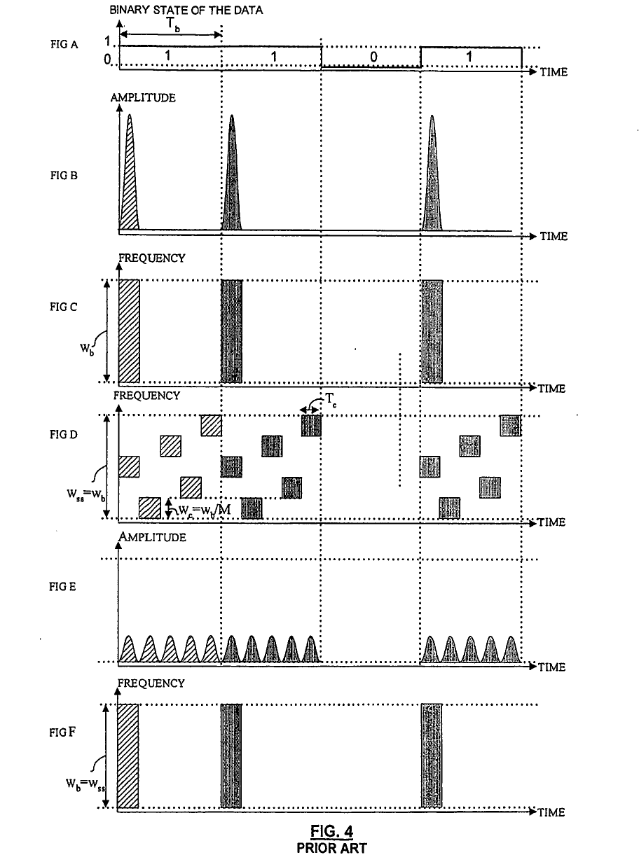

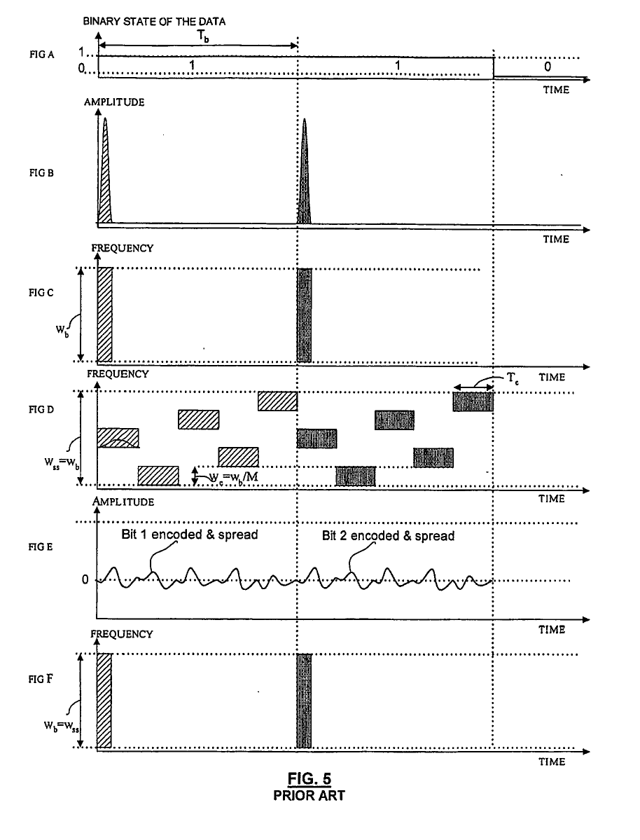

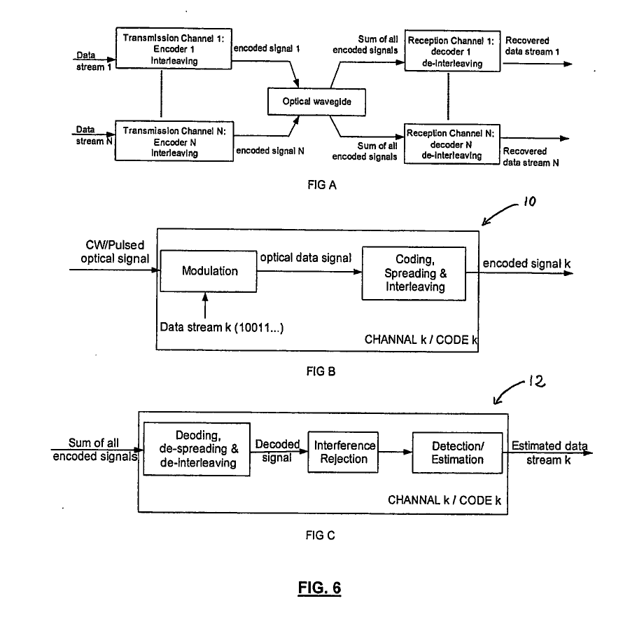

While the invention will be described in conjunction with example embodiments, it will be understood that it is not intended to limit the scope of the invention to such embodiments. On the contrary, it is intended to cover all alternatives, modifications and equivalents as may be included as defined by the appended claims.

### DESCRIPTION OF PREFERRED EMBODIMENTS OF THE INVENTION

In the following description, similar features in the drawings have been given similar reference numerals and in order to lighten the figures, some elements are not referred to in some figures if they were already identified in a precedent figure.

The present invention concerns a practical implementation of fast frequency hopping-code division multiple access in optical networks.

The present invention and its preferred embodiments which will be described hereinafter provide next generation solution for fiber optic metropolitan access networks. OCDMA over WDM and Passive optical networks could also be attractive applications.

The present invention has several major advantages. Firstly, it increases the ability to accommodate higher transmission bandwidth. Moreover, it allows smaller packaging, and furthermore, it increases the capability to support arbitrary phase-coded chips when a coherent light source is used.

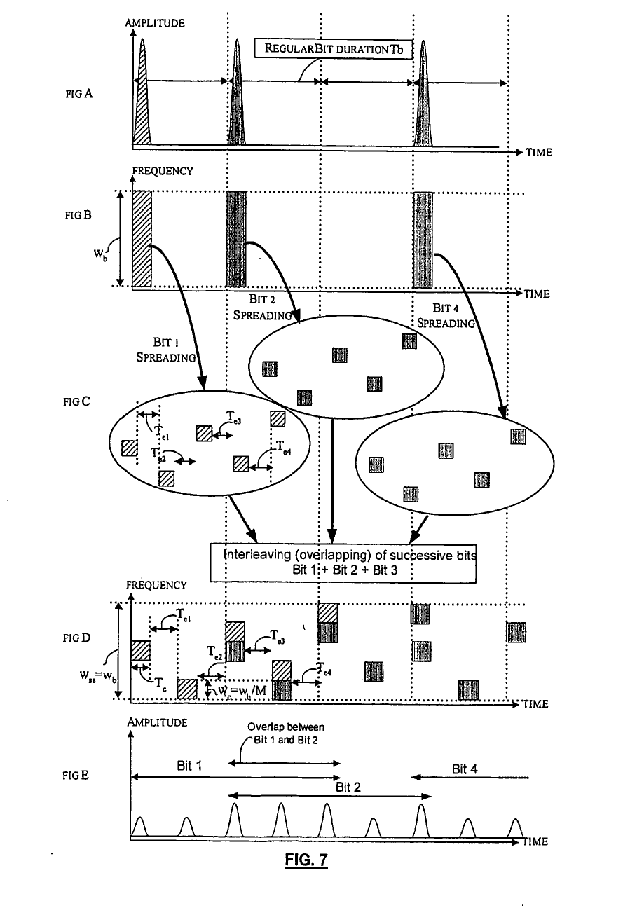

The invented technique preferably adds two signal processing operations in both sides of the network; the transmitter and the receiver. With reference to FIGS. 6A to 6C, there is provided a method of fast frequency hopping CDMA coding of optical signals for transmission over an optical network. The method comprises the step a) of providing a fast frequency hopping CDMA coded optical signal comprising a plurality of user's bits of a plurality of users. The user's bits of a particular user are arranged in user's bits streams. Each user's bit comprises a predetermined number of chips. The method also comprises the step b) of over spreading, we refer as OSP, in a time axis each of the user's bits of the fast frequency hopping CDMA coded optical signal. Over spreading means that chip pulses are transmitted through the network with extended inter-chip distance. In other words, this step consists in increasing the physical distance between the chip pulses of the user's bits. This step could imply phase coding if the light source is coherent. Phase coding provides a greater flexibility in the coding technique and the number of useable codes can then be increased. The method also comprises the step c) of interleaving (or overlapping) each of the user's bits of a given user with a successive user's bit of the given user. Interleaving means that consecutive bits from the same user could overlap in time together, hence breaking the non-overlapping condition of the prior art. Spreading operation in OCDMA system is used to be inherent (or simultaneous) to the encoding operation. In the preferred implementation embodiments of the present invention, OSP operation may also advantageously be engineered (or achieved) simultaneously within the coding and spreading operations. Interleaving operation could also be, in some cases implemented within the encoding, spreading and OSP operations. According to the present invention, the encoding devices could be engineered in order to achieve all operations at once. FIG. 6B illustrates such an encoding device, we refer as transmitter 10. It should also be noted that interleaving operation could be performed prior to the over spreading operation.

Once the signal has been over spread and interleaved, it is transmitted over the optical network (step d)). Preferably, the optical network is fiber based and, more preferably, the optical network is a fiber optic metropolitan access network. Similarly, in the receiver, the invented technique preferably adds two operations. Indeed, the method comprises the step e) of over de-spreading, we refer as ODSP, in the time axis each of the user's bits of the fast frequency hopping CDMA coded optical signal. In other words, step e) compensates for the increased physical distance between the chip pulses (i.e., compensates for OSP in the transmitter), and could imply phase decoding if the light source is coherent (i.e., compensates for phase shifts created in the transmitter during the phase coding operation). The method also comprises the step f of de-interleaving (or de-overlapping) each of the user's bits of the fast frequency hopping CDMA coded optical signal from the successive user's bit. As previously mentioned in the case of the transmitter, de-interleaving operation could also b performed prior to the over de-spreading operation. These two operations could also be simultaneously performed. Also, it is worth mentioning that, depending on the number of chips, a plurality of user's bits can be interleaved before the transmission. FIG. 6C illustrates a receiver 12 according to the present invention.

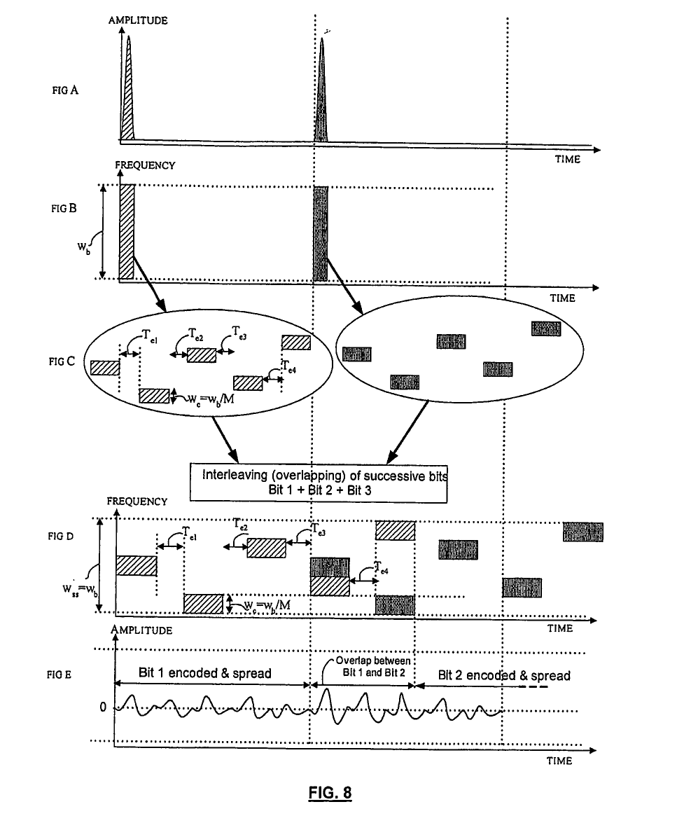

FIG. 7 describes the different evolution steps of a signal through the transmission and reception chain, showing all of the signal processing steps in a new OFFH-CDMA optical communication system according to the present invention where and incoherent broadband source is used. FIG. 7A is an amplitude vs. time representation of On/Off keyed data using low duty-cycle return to zero (RZ) waveforms. The stream of data shown is 1101. In FIG. 7B, there is shown the frequency vs. time space occupied by a broadband (or multi-wavelength) data modulated signal. FIG. 7C is the frequency vs. time space occupied by discrete bits after encoding, spreading and over-spreading operations. Bit 1, Bit 2 and Bit 4 are shown, each of them has the value equal to ONE. Bit 3 has a value equal to ZERO. FIG. 7D is the frequency vs. time space occupied by the data stream after encoding, spreading, overspreading and interleaving operations. Interleaving allows bits from the same user to overlay at any point of time. FIG. 7E shows the amplitude vs. time curve describing the data stream after encoding, spreading, over spreading and interleaving operation. The signal shows pulses having the value of two times a chip amplitude. This corresponds to a coincidence between chip pulses coming from the same user but from consecutive overlaid encoded bits.

FIG. 8 is a description of the signal processing steps in a new OFFH-CDMA optical communication system according to the present invention when a coherent broadband source is used. FIG. 8A shows the amplitude vs. time On/Off keyed data using low duty-cycle return to zero (RZ) waveforms. The stream of data shown is 110. FIG. 8B illustrates the frequency vs. time space occupied by a coherent broadband laser modulated by the data signal. FIG. 8C is the Frequency vs. time space occupied by discrete bits after encoding, spreading and over-spreading operations. Bit 1 and Bit 2 are shown, each of which has the value equal to ONE. Bit 3 has a value equal to ZERO. FIG. 8D is the frequency vs. time space occupied by the data stream after encoding, spreading, overspreading and interleaving operations. Interleaving allows bits from the same user to overlay at any point of time. FIG. 8E is the amplitude vs. time curve describing the data stream after encoding, spreading, over spreading and interleaving operation. The signal shows pulses having a value higher that a chip amplitude. This corresponds to a coincidence between chip pulses coming from the same user but from consecutive overlaid encoded bits.

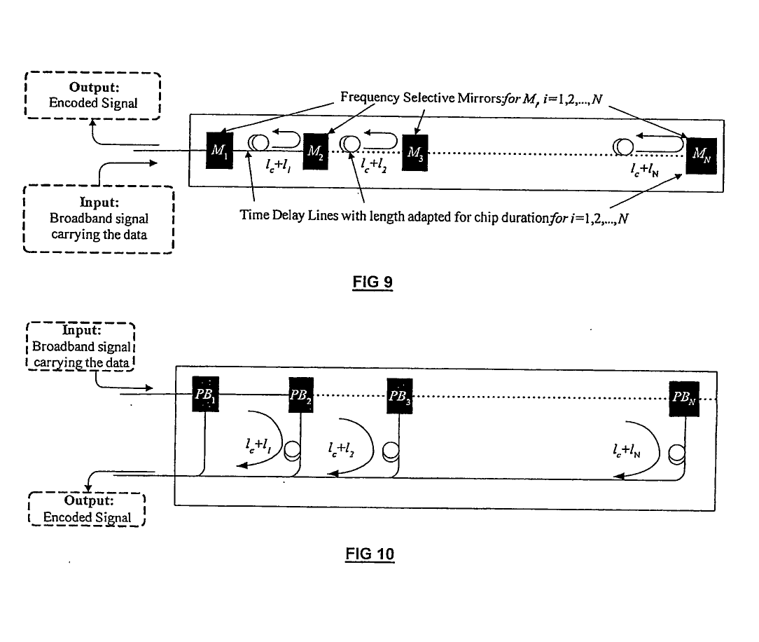

Referring to FIGS. 9, 10 and 11 there are shown different optical communication systems according to preferred embodiments of the present invention. Preferably, the method of the present invention is realised by inserting an additional delay Lₐ between each consecutive pair of filters of the encoder/decoder. The time spacing between the chip pulses is increased by a proportional value Tₐ and is therefore equal to T_{c}+Tₐ, where T_{c} is the duration of the chip pulse itself. The energy of a given data bit is consequently spread over a time interval longer than the original bit duration. Allowing an overlapping of consecutive data bits, does not degrade the transmission performance of the encoder, as it would for a radio-frequency based system. By introducing similar delays in the decoder, pulses coming from a particular data bit superpose to reconstruct the original signal, and interference is seen as such in the same manner as with the prior art systems. Only the statistics of the interference will be modified, depending on the delay length Lₐ. In this example, we assumed Iₐ=I₁=I₂=I₃, etc. Spacing lengths I_{c}+I₁, I_{c}+I₂, I_{c}+I₃, etc. are longer than the chip length L_{c}; The values of I₁, I₂, I₃, etc. are positive and could be equal or different.

Accordingly, the present invention provides a transmitter for transmitting over an optical network a fast frequency hopping CODMA coded optical signal comprising a plurality of user's bits of a plurality of users, each of said user's bits comprising a predetermined number of chips. The transmitter comprises an encoding means for over spreading in a time axis each of the user's bits of the fast frequency hopping CDMA coded optical signal and interleaving each of the user's bits of a given user with a successive user's bit of the given user. Preferably, the encoding means comprises a plurality of filtering devices, each inserting a time spacing between two successive chips of a user's bit.

In a further embodiment of the present invention, there is also provided an optical communication system for exchanging over an optical network a fast frequency hopping CDMA coded optical signal comprising a plurality of user's bits of a plurality of users. The optical communication system is provided with a transmitter as previously described. The optical communication system is also provided with a receiver. The receiver comprises a decoding means for over de-spreading in a time axis each of the user's bits of the fast frequency hopping CDMA coded optical signal and de-interleaving each of the user's bits of a given user from the successive user's bit of the given user.

In FIG. 9, the filtering devices of the encoder/decoder are shown to be band reflective filters of arbitrary type. Preferably, each of the filtering devices comprises a frequency selective mirror, each of them being serialized in an optical link. In the illustrated embodiment, the optical link is provided with a plurality of time delay lines. Each of the time delay lines extends between two adjacent frequency selective mirrors.

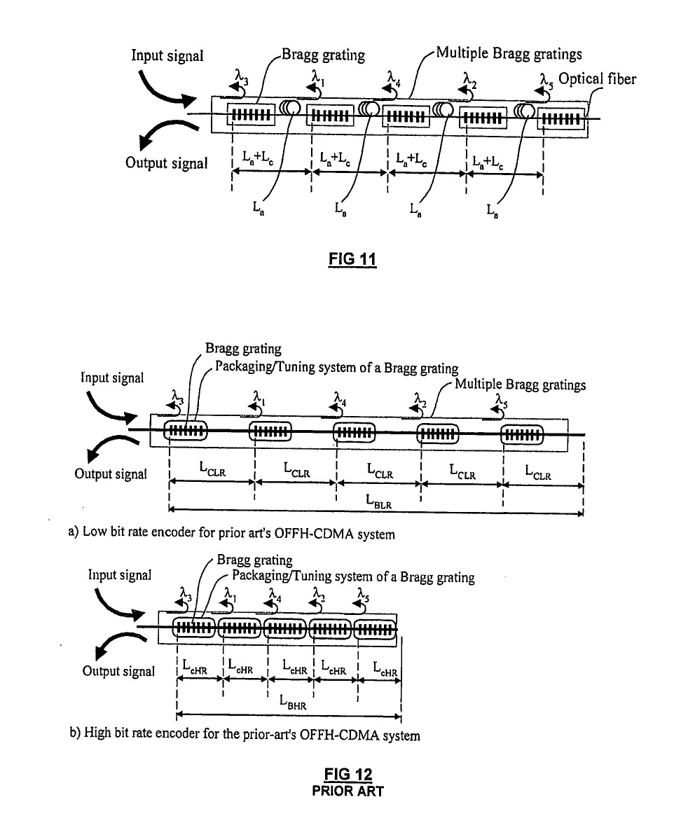

FIG. 10 shows an alternative embodiment where filtering devices with one input and two output (referred as PB) are used. From a broadband signal at its input, the device selects one specific wavelength for one output and the remaining spectrum for the other output.

FIG. 11 finally shows an encoder/decoder based on Bragg gratings, wherein a plurality of Bragg gratings of a predetermined length are serialized in an optical link. The optical link is also provided with a plurality of time delay lines, each of the time delay lines extending between two adjacent gratings. The time delay lines can be chosen of the same length or different length could also be used, according to a particular application.

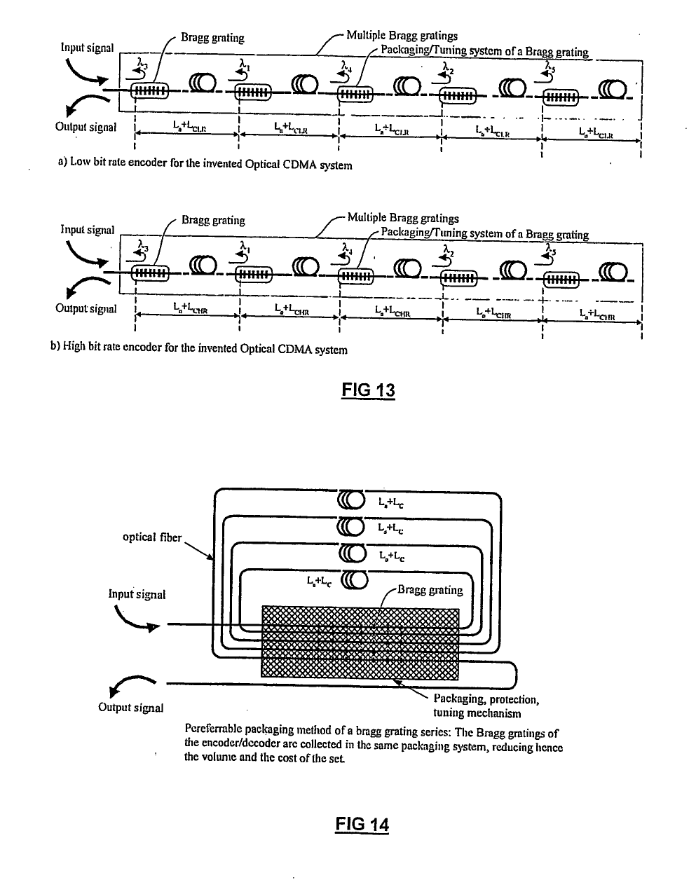

In FIGS. 13A and 13B there is shown respectively a low and a high bit rate encoders according to the present invention. The proposed system allows overlay between successive encoded data bits by inserting a determined additional propagation length (Lₐ) between gratings. The length Lₐ can be chosen so long it allows the required lengths of the gratings and packaging/tuning settings while maintaining a performance that is at least similar to that of the prior art's system.

It will be readily understood that the present invention virtually remove all the previously explained limitations on the chip rates and data rates, while avoiding putting any restriction to the total length of the multiple system and to the length of each single grating. The value of the delay length Lₐ is advantageously optimised in order to maximise the system perfornmance, and minimise interference. In addition, it can be selected so as to allow flexibility and ease in the design of the grating, and practical packaging and tuning. Advantageously, the overlapping of consecutive data spreads the energy of the bits equal to one, and reduces the zero intervals, giving the encoded signal the form of a low power signal always ON. The gain fluctuations in subsequent amplifiers are therefore reduced, and so is the variance of the interference. Additionally, the energy of interferers being also spread by the encoder, its overall effect is minimised.

The proposed encoder/decoder can be packaged more economically and in a smaller volume than that of the previous one. Due to the additional length Lₐ, the gratings can be collected in a reduced volume, assembled in parallel on the same packaging/tuning mechanism (or material). The proposed encoding technique requires only one packaging/tuning mechanism for all gratings instead of using a different mechanism for each. The additional length Lₐ can be selected so as this allows the flexible and economic packaging shown in FIG. 14.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. A method of fast frequency hopping CDMA coding of optical signals for transmission over an optical network, said method comprising the steps of:
a) providing a fast frequency hopping CDMA coded optical signal comprising a plurality of user's bits of a plurality of users;
b) over spreading in a time axis each of said user's bits of said fast frequency hopping CDMA coded optical signal;
c) interleaving each of said user's bits of a given user with a successive user's bit of said given user;
d) after steps a), b) and c), transmitting said fast frequency hopping CDMA coded optical signal over the optical network;
e) after step d), over de-spreading in the time axis each of said user's bits of said fast frequency hopping CDMA coded optical signal; and
f) de-interleaving each of said user's bits of said fast frequency hopping CDMA coded optical signal from said successive user's bit.

2. The method of fast frequency hopping CDMA coding of optical signals according to claim 1, wherein said step b) is performed prior to said step c).

3. The method of fast frequency hopping CDMA coding of optical signals according to claim 1, wherein said step c) is performed prior to said step b).

4. The method of fast frequency hopping CDMA coding of optical signals according to claim 1, wherein each of said steps b) and c) are simultaneously performed.

5. The method of fast frequency hopping CDMA coding of optical signals according to claim 1, wherein said step e) is performed prior to said step f).

6. The method of fast frequency hopping CDMA coding of optical signals according to claim 1, wherein said step f) is performed prior to said step e).

7. The method of fast frequency hopping CDMA coding of optical signals according to claim 1, wherein each of said steps e) and f) are simultaneously performed.

8. The method of fast frequency hopping CDMA coding of optical signals according to claim 1, wherein said step b) is simultaneously performed with a coding and a spreading operations providing the fast frequency hopping CDMA coded optical signal.

9. The method of fast frequency hopping CDMA coding of optical signals according to claim 8, wherein said step c) is simultaneously performed with said step b).

10. The method of fast frequency hopping CDMA coding of optical signals according to claim 1, wherein said fast frequency hopping CDMA coded optical signal is encoded with an encoding means comprising an incoherent broadband source.

11. The method of fast frequency hopping CDMA coding of optical signals according to claim 1, wherein said fast frequency hopping CDMA coded optical signal is encoded with an encoding means comprising a coherent broadband source.

12. The method of fast frequency hopping CDMA coding of optical signals according to claim 11, wherein said step b) comprises the sub-step of phase coding said fast frequency hopping CDMA coded optical signal.

13. The method of fast frequency hopping CDMA coding of optical signals according to claim 12, wherein said step e) of over de-spreading comprises the sub-step of phase decoding said fast frequency hopping CDMA coded optical signal.

14. The method of fast frequency hopping CDMA coding of optical signals according to claim 1, wherein said optical network is fiber optic based.

15. The method of fast frequency hopping CDMA coding of optical signals according to claim 1, wherein said optical network is a fiber optic metropolitan access network.

16. The method of fast frequency hopping CDMA coding of optical signals according to claim 1, wherein a plurality of user's bits are interleaved before transmission.

17. A transmitter for transmitting over an optical network a fast frequency hopping CDMA coded optical signal comprising a plurality of user's bits of a plurality of users, each of said user's bits comprising a predetermined number of chips, said transmitter comprising an encoding means for over spreading in a time axis each of said user's bits of said fast frequency hopping CDMA coded optical signal and interleaving each of said user's bits of a given user with a successive user's bit of said given user.

18. The transmitter according to claim 17, wherein said encoding means comprises a plurality of filtering devices, each inserting a time spacing between two successive chips of a user's bit.

19. The transmitter according to claim 18, wherein each of said filtering devices comprises a band reflective filter.

20. The transmitter according to claim 18, wherein each of said filtering devices comprises a frequency selective mirror.

21. The transmitter according to claim 20, wherein said frequency selective mirrors are serialized in an optical link.

22. The transmitter according to claim 21, wherein said optical link comprises a plurality of time delay lines, each of said time delay lines extending between two adjacent frequency selective mirrors.

23. The transmitter according to claim 18, wherein each of said filtering devices are serialized in an optical link, each of said filtering devices comprising an input for receiving a broadband signal and a first and a second output, said first output selecting a specific wavelength of said broadband signal for outputting through a optical time delay line.

24. The transmitter according to claim 18, wherein each of said filtering devices comprises a Bragg grating of a predetermined length, each of said gratings being serialized in an optical link.

25. The transmitter according to claim 24, wherein said optical link comprises a plurality of time delay lines, each of said time delay lines extending between two adjacent gratings.

26. The transmitter according to claim 25, wherein each of said time delay lines has an identical length.

27. An optical communication system for exchanging over an optical network a fast frequency hopping CDMA coded optical signal comprising a plurality of user's bits of a plurality of users, said optical communication system comprising:
a transmitter comprising an encoding means for over spreading in a time axis each of said user's bits of said fast frequency hopping CDMA coded optical signal and interleaving each of said user's bits of a given user with a successive user's bit of said given user; and
a receiver comprising a decoding means for over de-spreading in a time axis each of said user's bits of said fast frequency hopping CDMA coded optical signal and de-interleaving each of said user's bits of a given user from the successive user's bit of said given user.
